(19) United States
(12) Patent Application Publication
(10) Pub. No.: US 2016/0162986 A1
(43) Pub. Date: Jun. 9, 2016

(54) SYSTEMS AND METHODS FOR DETERMINING A VALUE OF COMMERCIAL REAL ESTATE

(71) Applicant: MasterCard International Incorporated, Purchase, NY (US)

(72) Inventor: Debashis Ghosh, Charlotte, NC (US)

(21) Appl. No.: 14/564,440

(22) Filed: Dec. 9, 2014

(51) Int. Cl. G06Q 40/00; G06Q 50/16

(52) U.S. Cl. CPC G06Q 40/00; G06Q 50/16

(57) ABSTRACT

A computer-implemented method for evaluating real estate assets is implemented by a real estate evaluation computing device in communication with a memory. The method includes receiving a set of property factors, receiving a set of income factors, receiving a previous real estate rating for the real estate asset, receiving a set of merchant data associated with the merchant, the set of merchant data including a set of transaction data, determining a merchant revenue forecast based at least in part on the set of merchant data, determining a present real estate rating, determining that a difference between the present real estate rating and the previous real estate rating exceeds a rating threshold indicating a possible change in value of the real estate asset, and transmitting an alert to a user device indicating the possible change in value of the real estate asset.

### BACKGROUND OF THE DISCLOSURE

The field of the disclosure relates generally to real estate, and more specifically to methods and systems for monitoring the value of commercial real estate assets.

Many owners of commercial real estate own multiple commercial real estate assets (“real estate assets”). A group of such real estate assets owned by a particular owner may be referred to as a commercial real estate portfolio. Similarly, many commercial lenders lend to prospective commercial real estate owners (“borrowers”). Such commercial lenders may be described as having commercial real estate portfolios for lending. Management of such portfolios by owners or lenders depends, at least in part, on accurate evaluations, monitoring, and optimizing of the real estate assets. However, efficient management of such commercial real estate portfolios, by owners or lenders, is a time-consuming activity. Notably, the steps of evaluating, monitoring, and optimizing commercial real estate assets are time-consuming. For a variety of reasons, collecting and processing data for such steps is complicated and resource intensive. As a result, in many examples, evaluation of the value of real estate assets is often conducted by owners and lenders infrequently (e.g., at the beginning and ending of the ownership of a particular real estate asset). Thus, commercial real estate owners and lenders may have out-of-date information on the value of commercial real estate and may not be aware of changes or potential changes in the value of the commercial real estate. Accordingly, improved methods of monitoring commercial real estate portfolios may be desired to facilitate improved evaluations and optimizations.

### BRIEF DESCRIPTION OF THE DISCLOSURE

In one aspect, a computer-implemented method for evaluating real estate assets is provided. The method is implemented by a real estate evaluation computing device in communication with a memory. The method includes receiving a set of property factors associated with a real estate asset, wherein the real estate asset is associated with a merchant renting the real estate asset, receiving a set of income factors associated with the real estate asset, receiving a previous real estate rating for the real estate asset, receiving a set of merchant data associated with the merchant, the set of merchant data including a set of transaction data, wherein the set of transaction data is received at an interchange network, determining a merchant revenue forecast based at least in part on the set of merchant data, determining a present real estate rating for the real estate asset based on the set of property factors, the set of income factors, and the merchant revenue forecast, determining that a difference between the present real estate rating and the previous real estate rating exceeds a rating threshold indicating a possible change in value of the real estate asset, and transmitting an alert to a user device indicating the possible change in value of the real estate asset.

In another aspect, a real estate evaluation computing device for evaluating real estate assets is provided. The real estate evaluation computing device includes a memory for storing data, and a processor in communication with the memory. The processor is programmed to receive a set of property factors associated with a real estate asset, wherein the real estate asset is associated with a merchant renting the real estate asset, receive a set of income factors associated with the real estate asset, receive a previous real estate rating for the real estate asset, receive a set of merchant data associated with the merchant, the set of merchant data including a set of transaction data, wherein the set of transaction data is received at an interchange network, determine a merchant revenue forecast based at least in part on the set of merchant data, determine a present real estate rating for the real estate asset based on the set of property factors, the set of income factors, and the merchant revenue forecast, determine that a difference between the present real estate rating and the previous real estate rating exceeds a rating threshold indicating a possible change in value of the real estate asset, and transmit an alert to a user device indicating the possible change in value of the real estate asset.

In a further aspect, computer-readable storage media for evaluating real estate assets is provided. The computer-readable storage media has processor-executable instructions embodied thereon. A computer includes at least one processor and a memory coupled to the processor. When executed by the computer, the processor-executable instructions cause the computer to receive a set of property factors associated with a real estate asset, wherein the real estate asset is associated with a merchant renting the real estate asset, receive a set of income factors associated with the real estate asset, receive a previous real estate rating for the real estate asset, receive a set of merchant data associated with the merchant, the set of merchant data including a set of transaction data, wherein the set of transaction data is received at an interchange network, determine a merchant revenue forecast based at least in part on the set of merchant data, determine a present real estate rating for the real estate asset based on the set of property factors, the set of income factors, and the merchant revenue forecast, determine that a difference between the present real estate rating and the previous real estate rating exceeds a rating threshold indicating a possible change in value of the real estate asset, and transmit an alert to a user device indicating the possible change in value of the real estate asset.

### BRIEF DESCRIPTION OF THE DRAWINGS

The figures listed below show example embodiments of the methods and systems described herein.

FIGS. 1-12 show example embodiments of the methods and systems described herein.

FIG. 1 is a schematic diagram illustrating an example multi-party payment card system for enabling payment-by-card transactions and monitoring real estate assets in accordance with one embodiment of the present disclosure.

FIG. 2 is an expanded block diagram of an example embodiment of a computer system used in processing payment transactions that includes a real estate evaluation computing device in accordance with one example embodiment of the present disclosure.

FIG. 3 illustrates an is an expanded block diagram of an example embodiment of a computer device architecture of a system used to monitor real estate assets in accordance with one example embodiment of the present disclosure.

FIG. 4 illustrates an example configuration of a server system such as the real estate evaluation computing device of FIGS. 2 and 3 used to monitor real estate assets in accordance with one example embodiment of the present disclosure.

FIG. 5 is a simplified data flow diagram for monitoring real estate assets using the real estate evaluation computing device of FIGS. 2 and 3.

FIG. 6 is a simplified diagram of an example method for monitoring real estate assets using the real estate evaluation computing device of FIGS. 2 and 3.

FIG. 7 is a diagram of components of one or more example computing devices that may be used in the environment shown in FIG. 2.

FIGS. 8-12 are illustrative screenshots provided by the real estate evaluation computing device to allow the monitoring of real estate assets in accordance with one example embodiment of the present disclosure.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

Many owners of commercial real estate own multiple commercial real estate assets (“real estate assets”). A group of such real estate assets owned by a particular owner may be referred to as a commercial real estate portfolio. Similarly, many commercial lenders lend to prospective commercial real estate owners (“borrowers”). Such commercial lenders may be described as having commercial real estate portfolios for lending. Management of such portfolios by owners or lenders depends, at least in part, on accurate evaluations, monitoring, and optimizing of the real estate assets. However, efficient management of such commercial real estate portfolios, by owners or lenders, is a time-consuming activity. Notably, the steps of evaluating, monitoring, and optimizing commercial real estate assets are time-consuming. For a variety of reasons, collecting and processing data for such steps is complicated and resource intensive. As a result, in many examples, evaluation of the value of real estate assets is conducted by owners and lenders infrequently (e.g., at the beginning and ending of the ownership of a particular real estate asset). Thus, commercial real estate owners and lenders may have out-of-date information regarding the value of commercial real estate and may not be aware of changes or potential changes in the value of the commercial real estate.

The systems and methods described herein facilitate the evaluation of real estate assets or, alternately phrased, the monitoring of the value of real estate assets. The systems and methods described herein are implemented by a computing device that may be referred to as a “real estate evaluation computing device”. The real estate evaluation computing device includes a processor in communication with a memory. The real estate evaluation computing device is configured to: (i) receive a set of property factors associated with a real estate asset, wherein the real estate asset is associated with a merchant renting the real estate asset; (ii) receive a set of income factors associated with the real estate asset; (iii) receive a previous real estate rating for the real estate asset; (iv) receive a set of merchant data associated with the merchant, the set of merchant data including a set of transaction data, wherein the set of transaction data is received at a payment network; (v) determine a merchant revenue forecast based at least in part on the set of merchant data; (vi) determine a present real estate rating for the real estate asset based on the set of property factors, the set of income factors, and the merchant revenue forecast; (vii) determine that a difference between the present real estate rating and the previous real estate rating exceeds a rating threshold indicating a possible change in value of the real estate asset; and (viii) transmit an alert to a user device indicating the possible change in value of the real estate asset.

### Setup Phase

In the example embodiment, the real estate evaluation computing device is configured to receive information describing a commercial real estate asset (or commercial real estate assets) in a commercial real estate portfolio during a configuration period referred to as a “Setup Phase”. Information received in the Setup Phase to define the commercial real estate assets may be referred to as “real estate definitions.” In an example embodiment, a user (e.g., a commercial real estate owner or a commercial real estate lender) may access the real estate evaluation computing device (directly or via any suitable client user computing device in communication with the real estate evaluation computing device) and may provide such real estate definitions.

As used herein, “commercial real estate portfolio” (alternately referred to as a “portfolio”) refers to a collection of commercial real estate assets, generally. In the example embodiment, a commercial real estate portfolio may be described by real estate definitions and represented as an electronic record that may be referred to as a “commercial real estate portfolio record” or a “portfolio record”. Accordingly, the real estate evaluation computing device processes real estate definitions associated with a plurality of commercial real estate assets to create a portfolio record. More specifically, because real estate definitions are associated with a specific commercial real estate asset, a plurality of real estate definitions (each associated with a specific commercial real estate asset) are processed to create a portfolio record containing information (or records) regarding each of the specific commercial real estate assets. Further, as described herein, each commercial real estate asset may further be associated with a tenant merchant that currently rents at least a portion of the commercial real estate asset. Such tenant merchants may alternately be referred to as “tenants” or “merchants” herein.

Real estate definitions include information associated with commercial real estate assets including property identifiers, property location information, property condition information, property layout information, property age information, property classification information (or property categorization), property ownership tenure information, property legal information, tenant option information, past tenancy information, and current tenancy information.

Property identifiers may include known names of commercial real estate assets (e.g., “XYZ Mall”) or any suitable unique alphanumeric identifier. In an example embodiment, the real estate evaluation computing device uses property identifiers to designate each commercial real estate asset within the portfolio record. As described below, a user may accordingly view and manage individual commercial real estate assets distinguished by identifiers including property identifiers.

Property location information may include any information defining the location of a commercial real estate asset. In some examples, property location information may include physical addresses, geographic coordinates in latitude and longitude, elevation information (e.g., a floor or floors of a building associated with the commercial real estate asset), and any other suitable information. In some examples, property location information may include boundary information defining a physical area (or areas) containing the commercial real estate asset. In an example embodiment, property location information may be used by the real estate evaluation computing device to identify the commercial real estate asset graphically (i.e., to provide visually mapped information showing the physical location of the commercial real estate asset).

In additional embodiments, property location information may also be used by the real estate evaluation computing device to monitor the value of the commercial real estate asset. In a first example, the real estate evaluation computing device may identify a neighborhood, region, or area associated with the commercial real estate asset using any suitable mapping or reference system. The real estate evaluation computing device may obtain information related to the relative, subjective, or objective qualities of the neighborhood, region, or area. For example, neighborhoods, regions, or areas may be associated with average commercial real estate asset values per square foot, social media reviews or opinions, investment profiles, and other suitable data that may be used to determine quantitative or qualitative assessments of the neighborhoods, regions, or areas containing the commercial real estate asset. Accordingly, in the EEvaluation Phase (described below), the real estate evaluation computing device may accordingly adjust the value of the commercial real estate asset (as reflected in the real estate rating) based on such determined assessments, as described herein. In a second example, the real estate evaluation computing device may identify neighbors comparable to the commercial real estate asset (“comps”) and use such comps to adjust the value of the commercial real estate asset in the Evaluation Phase.

Property condition information may include any suitable information related to the design, maintenance, and upkeep of a commercial real estate asset. Property condition information may accordingly describe building materials used in the construction of the commercial real estate asset, known needed repairs, repair history, and costs associated with the existing construction and needed repair. In an example embodiment, the real estate evaluation computing device may use property condition information to adjust the value of the commercial real estate asset (as reflected in the real estate rating) in the Evaluation Phase. For example, the real estate evaluation computing device may process property condition information indicating that the commercial real estate asset is well-maintained and kept and determine that the commercial real estate asset value does not need adjustment based on condition in the Evaluation Phase. Alternately, the real estate evaluation computing device may process property condition information indicating that the commercial real estate asset is not well maintained and kept and determine that the commercial real estate asset value should be negatively adjusted in the Evaluation Phase.

Property layout information may include any suitable description of the physical area of the commercial real estate asset in any suitable units including square feet, square miles, and acres. Property layout information may also include information describing sub-divisions of the commercial real estate asset. In some examples, commercial real estate assets may include multiple divisions that may be rented, leased, sold to, or otherwise made available to commercial tenants. In such examples, the real estate evaluation computing device may process property layout information and identify such sub-divisions of the commercial real estate asset. As described below and herein, the real estate evaluation computing device may accordingly use such identified sub-divisions to associate particular merchants as tenants of sub-divisions.

Property age information includes information regarding the age of the entirety of or individual sections of the commercial real estate asset and may also include the age of repairs or replacements made to portions or sections of the commercial real estate asset. In an example embodiment, the real estate evaluation computing device may use property age information to adjust the value of the commercial real estate asset as reflected in the real estate rating. For example, the real estate evaluation computing device may process property age information indicating that the commercial real estate asset is very old to adjust the value of the commercial real estate asset downward.

Property classification information includes information categorizing the commercial real estate asset within categories that may be relevant to the monitoring of the value of the commercial real estate asset. For example, property classification information may categorize a commercial real estate asset as, for example, “retail”, “office”, “warehouse”, “manufacturing”, “outdoor mall”, “indoor mall” and any other suitable information. In an example embodiment, the real estate evaluation computing device may use property classification information to adjust the value of the commercial real estate asset as reflected in the real estate rating. For example, the real estate evaluation computing device may process property classification information indicating that the commercial real estate asset is of a “warehouse” category and determine that average warehouse values have declined. Accordingly, the real estate evaluation computing device may adjust the value of the commercial real estate asset downward based on such categorization.

Property ownership tenure information includes information related to the history of ownership of the commercial real estate asset by the current owner and by previous owners. As described below, such information may be useful in monitoring the value of the commercial real estate asset because, for example, the real estate evaluation computing device may weigh the previous purchase price of the commercial real estate asset more if the previous purchase is recent (i.e., if the ownership tenure is relatively short) in the Evaluation Phase. Further, in some examples, the real estate evaluation computing device may adjust evaluations downward if the commercial real estate asset has been sold repeatedly with short ownership tenures (i.e., if the commercial real estate asset has “flipped” repeatedly) to discount potential distortionary effects of such sales.

Property legal information includes information related to the legal aspects of the commercial real estate asset. Property legal information may include, for example, taxes associated with the commercial real estate asset, zoning information indicating authorized uses for the commercial real estate asset, covenants on the commercial real estate asset, easements on the commercial real estate asset, other burdens on the commercial real estate asset, previous lawsuits associated with the commercial real estate asset, and insurance information related to the commercial real estate asset. In an example embodiment, the real estate evaluation computing device may use property legal information to adjust the value of the commercial real estate asset. For example, when a commercial real estate asset is burdened by restrictive covenants, the real estate evaluation computing device may identify such restrictive covenants and adjust the value of the commercial real estate asset based on such restrictive covenants.

Tenant options information includes information related to the possible tenant options for the commercial real estate asset. Accordingly, tenant option information may relate to property layout information (that may identify sub-divisions that may be rented by tenants). Tenant option information may include, for example, the total number of units that may be rented or leased within the commercial real estate asset.

Current tenancy information includes information related to the current tenants of the commercial real estate asset. Accordingly, current tenancy information may include, for example, business identifiers for businesses that are renting the commercial real estate asset, rental payment history for each current tenant, vacant units, and information related to the tenure of tenancy for each current tenant. Business identifiers may identify a particular merchant renting all or a portion of the commercial real estate asset. In some examples, such a renter may be a company with multiple locations (e.g., a chain). In such examples, the business identifier may further identify an individual location for such a merchant. As described below, such business identifiers may be used to associate transaction data, social media data, visit data, and other suitable data with the renter. Further, business identifiers may include a reference number associated with an evaluation of the renter on an external evaluation service. Accordingly, the real estate evaluation computing device may obtain and process transaction data, social media data, visit data, external evaluation data, and other data related to the renter and accordingly adjust the value of the commercial real estate.

In many examples, a commercial real estate property may include a location for a merchant of greater importance that may be referred to as an “anchor tenant.” The real estate evaluation computing device may allow current tenancy information to include a designation for an anchor tenant.

Past tenancy information includes information related to the previous tenants of the commercial real estate asset. Accordingly, past tenancy information may include, for example, business identifiers for businesses that previously rented the commercial real estate asset, rental payment history, vacant unit history, and information related to the tenure of tenancy for each previous tenant.

The real estate evaluation computing device also generates a unique portfolio identifier in the Setup Phase to identify the commercial real estate portfolio record. Accordingly, a user device (operated by a user) may provide such a portfolio identifier at a later point in time and retrieve the commercial real estate portfolio record to review or monitor the commercial real estate portfolio defined by the record.

In at least some examples, the real estate evaluation computing device also receives a plurality of investment goals associated with each commercial real estate asset. At least some owners of and lenders for commercial real estate may have varying financial goals for a commercial real estate asset. Some investors may seek to maximize the evaluation of a commercial real estate asset and have some risk tolerance. Other investors may seek to minimize risk and accept lower increases in the evaluation of a commercial real estate asset. Because investors and lenders may vary in their underlying interests, the real estate evaluation computing device may be configured to monitor commercial real estate assets pursuant to such investment goals. For example, the scoring of commercial real estate assets and the commercial real estate portfolio (described herein) may be adjusted depending on the plurality of investment goals.

### Validation Phase

The real estate evaluation computing device processes real estate definitions and allows a user to verify that the commercial real estate portfolio record has been created properly. Such a process may be referred to as a “Validation Phase” performed by the real estate evaluation computing device. Specifically, the real estate evaluation computing device displays the commercial real estate portfolio record as defined by real estate definitions and allows a user device (controlled by a user) to authenticate the commercial real estate portfolio record. In some examples, a user may verify that current tenancy information (including tenant merchant information) is accurate. In other examples, a user may verify that property identifiers, property location information, property condition information, property layout information, property age information, property classification information, property categorization, property ownership tenure information, property legal information, tenant option information, past tenancy information, and current tenancy information are correctly defined in real estate definitions.

In many examples, the Validation Phase includes the verification of specific information regarding tenants (or merchants) at each commercial real estate asset. In such examples, unique identifiers for ratings services may be provided during the Setup Phase for each merchant at each commercial real estate asset. Accordingly, in the Validation Phase, the merchant information may be compared to information that is automatically retrieved from the ratings services based on the provided unique identifiers. As a result, a user may verify that the information from the ratings services corresponds to the associated merchants.

If a user determines that the commercial real estate portfolio record has not been created properly, the user may return to the Setup Phase and resolve any errors in the record.

### Evaluation Phase

In an example embodiment, the real estate evaluation computing device determines a real estate rating associated with the commercial real estate asset in a process that may be referred to as the “Evaluation Phase”. As described below, the Evaluation Phase includes the real estate evaluation computing device receiving a plurality of information related to each real estate asset defined in the commercial real estate portfolio record (“portfolio record”), receiving information related to tenants (or merchants) of each real estate asset of the portfolio record, determining a merchant revenue forecast for each merchant of each real estate asset of the portfolio record, and determining a real estate rating of each real estate asset and a real estate rating of the portfolio record. The process is described below.

In one example embodiment, the real estate evaluation computing device values commercial real estate assets and the portfolio record using information related to each commercial real estate asset in the portfolio record and information related to each merchant (or tenant) of each commercial real estate asset.

The real estate evaluation computing device values commercial real estate assets of the portfolio record using underlying characteristics of the commercial real estate asset. Such characteristics may be referred to as “property factors.”

The real estate evaluation computing device receives property factors associated with each commercial real estate asset of the portfolio record. Property factors are information related to overall characteristics of each commercial real estate asset. However, property factors do not include characteristics related to income associated with the commercial real estate asset. Property factors may therefore include information derived based on real estate definitions, described above and herein. Property factors may include, for example and without limitation, information derived from property identifiers, property location information, property condition information, property layout information, property age information, property classification information (or property categorization), property ownership tenure information, and property legal information. In an example embodiment, the real estate evaluation computing device may receive and store property factors for each commercial real estate asset at a real estate database that is in communication with the real estate evaluation computing device. Alternately, property factors may be stored and received at any suitable storage device.

Phrased succinctly, property factors represent an intrinsic value of the commercial real estate asset without considering income streams associated with the commercial real estate asset. Therefore, property factors reflect information that may be used to gauge the value of each real estate asset including physical characteristics, neighborhood characteristics, maintenance, layout, and comparable property values.

As described herein, property factors may be used to create an estimated value for each commercial real estate asset. In one example, property factors may be used to estimate the intrinsic value of a commercial real estate asset based on the age and condition of the asset, the geographic location and neighborhood of the asset, and the physical layout and structure of the asset. Accordingly, the real estate evaluation computing device may determine an intrinsic value for each commercial real estate asset and apply such an analysis to determine a real estate rating. In one example, the real estate evaluation computing device may identify a weight or function associated with each property factor and determine the intrinsic value based on a sum of the function of each property factor or alternately based on the sum of the weighted property factors.

Property factors describe inherent characteristics of real estate assets that are independent of the income streams of such real estate assets (and also independent of actual rental data for the real estate assets.) Property factors may also include any such tax rates or tax amounts for a period of time, comparable real estate asset evaluations for neighboring or nearby real estate (“comps”), structural definitions of the real estate asset such as square footage, age of the real estate asset, maintenance condition of the real estate asset, ownership tenure for the real estate asset, classification of the real estate asset, and maximum tenancy for the real estate asset.

The real estate evaluation computing device also values commercial real estate assets based on income characteristics associated with the commercial real estate asset. Such characteristics may be referred to as “income factors.”

The real estate evaluation computing device accordingly receives income factors associated with each commercial real estate asset. Specifically, the real estate evaluation computing device receives a second set of informational factors related to income associated with each commercial real estate asset. Income factors may relate to historic income, current income, and projected income. Accordingly, in some examples, income factors may include tenant option information, past tenancy information, and current tenancy information. Income factors are relevant to determining the value of a commercial real estate asset because income streams are typically factored into the value of commercial real estate, generally. In an example embodiment, the real estate evaluation computing device may receive and store income factors for each commercial real estate asset at a real estate database that is in communication with the real estate evaluation computing device. Alternately, income factors may be stored and received at any suitable storage device.

As described herein, income factors may be used to create a financial model for the value of each commercial real estate asset. In one example, income factors may include rental income streams, projected rental increases, and costs including property taxes, maintenance, and administration costs. Accordingly, the real estate evaluation computing device may determine a cash flow analysis for each commercial real estate asset and apply such an analysis to determine a real estate rating.

The real estate evaluation computing device also values commercial real estate assets based on merchant characteristics associated with the merchant tenants of the commercial real estate asset. Such characteristics may be referred to as “a set of merchant data”.

The real estate evaluation computing device also receives a set of merchant data associated with each merchant (or tenant) of each real estate asset of the portfolio record. The set of merchant data may include any suitable information related to each merchant renting property at each commercial real estate asset. In one example, the set of merchant data includes transaction data for each merchant associated with the commercial real estate asset received from the interchange network. Such transaction data may be referred to as “sales receipts”. In additional examples, the real estate evaluation computing device may receive information associated with transaction data or derive such information including, for example, average transaction sizes, average transaction growth rates, total transaction growth rates, transaction volatility, transaction trends, and transaction seasonality. Such data may also be received from the interchange network. Further, the set of merchant data may include, for example, visit data indicating the number of shoppers visiting the merchant location over a particular period of time, social media data indicating the popularity of the merchant and opinions regarding the merchant, and online reviews of the merchant. Such data may be retrieved by the real estate evaluation computing device directly accessing online data, social media data, and merchant traffic data. Alternately, such data may be received from external systems or a real estate database.

As described herein, the set of merchant data may be used to determine a merchant revenue forecast. Generally, the ability of merchants to pay for their rental costs is associated with their income. Although some merchants may take losses for periods of time, over the long term merchants generally require a minimum revenue level to pay their rental costs. Accordingly, the merchant revenue forecast represents projected incomes for each merchant over a time period. The merchant revenue forecast may be useful to determine whether a merchant can continue paying the rent. Specifically, the real estate evaluation computing device identifies a plurality of forecast factors in the merchant data and processes the forecast factors to determine the merchant revenue forecast. Because the merchant revenue forecast may be viewed as a proxy for the ability of the merchant to pay real estate rents, the merchant revenue forecast also may reflect a confidence level in the income stream for each commercial real estate asset. Accordingly, the real estate rating may be adjusted based on the merchant revenue forecast. In at least some examples, the real estate evaluation computing device may specifically adjust the cash flow analysis based on the merchant revenue forecast.

The real estate evaluation computing device may determine the merchant revenue forecast using several techniques. The merchant revenue forecast may be a model of merchant revenue based at least in part on transaction data received at the interchange network (or derived from such transaction data) including, for example, transaction volume, average transaction sizes, average transaction growth rates, total transaction growth rates, transaction volatility, transaction trends, and transaction seasonality. In a first example, the model may be derived using regression techniques or other suitable modelling methods. The merchant revenue forecast may also be adjusted based on “early warning” indicators including visit data indicating the number of shoppers visiting the merchant location over a particular period of time, social media data indicating the popularity of the merchant and opinions regarding the merchant, and online reviews of the merchant. Such early warning indicators are useful because they may indicate an impending change in transaction data (e.g., social media spikes may indicate that more traffic is anticipated which may lead to increases in sales.)

The real estate evaluation computing device may also determine a “merchant revenue stability rating” based on the forecast factors. The merchant revenue stability rating represents a quantitative assessment of the merchant's ability to maintain present revenue and therefore to pay a rental fee associated with the commercial real estate asset. In one example, a real estate evaluation computing device may determine that a merchant's revenues are trending downwards because of declining transaction volume and declining average transaction sizes. In such an example, the real estate evaluation computing device may determine that the merchant revenue stability rating is decreasing. In a second example, early warning indicators may be used to identify a change in the merchant revenue stability rating. For example, a significant reduction in visits may indicate that the merchant will face a revenue decrease and not be able to pay rent. In one example, the merchant revenue stability rating is scored from zero to one hundred. A rating of zero may indicate that the merchant is very unlikely to maintain revenues sufficient to pay rent. A rating of fifty may indicate that the merchant can maintain revenues sufficient to pay rent. A rating of one hundred may indicate that the merchant can pay higher rental rates than are currently charged.

Relatedly, the real estate evaluation computing device may also determine a rent tolerance based on the merchant revenue stability rating and the merchant revenue forecast. More specifically, the real estate evaluation computing device is configured to model a projected rental payment ability (rent tolerance) based on merchant data. In one example, the real estate evaluation computing device may determine that a merchant may typically pay certain percentages of revenue as rental income. In order to allow merchants to maintain similar levels of profitability with rising and falling revenues, the real estate evaluation computing device may model projected revenues for each merchant and identify a tolerance range based on the identified certain percentages and the projected revenues. The real estate evaluation computing device may also be configured to alert a user when the rent tolerance exceeds or falls below the actual rent paid by the merchant.

Further, the real estate evaluation computing device is configured to analyze social media data, online review data, and visit data and identify early warning indicators that may be used to separately adjust the real estate rating.

Using the income factors, the property factors, and the set of merchant data, the real estate evaluation computing device may determine a real estate rating for each asset of the portfolio record. Based on each real estate rating for each real estate asset of the portfolio record, the real estate evaluation computing device may further identify a real estate rating for the portfolio record as a whole.

In a first example, a real estate rating for each commercial real estate asset of the portfolio record is determined by the real estate evaluation computing device. In this example, the real estate rating represents a calculation of the current financial value of each of the commercial real estate assets in the portfolio record. The real estate evaluation computing device may factor in previous sale prices of each commercial real estate asset to determine the real estate rating. In an example embodiment, weights are identified or determined for each income factor, each property factor, and the set of merchant data to determine the real estate rating for each real estate asset. In a second example, functions may be applied to each element of the income factors, property factors, and the set of merchant data to determine the real estate rating for each real estate asset. Further, the real estate evaluation computing device may determine a portfolio rating based on the plurality of real estate ratings associated with the portfolio record.

In a second example, the real estate rating represents a numeric score reflecting the quality of each real estate asset in the portfolio record. In at least some example embodiments, the real estate rating may be a numeric score between zero and one thousand indicating the performance of each commercial real estate asset or the portfolio record. In some examples, the real estate rating may be a score reflecting a comparison to the investment goals defined for each commercial real estate asset or the portfolio record. In an example embodiment, unique weights are identified or determined for each income factor and each property factor in calculating the real estate rating. Such weights are applied to each income factor and property factor to calculate the real estate rating.

The real estate evaluation computing device is configured to identify changes in real estate ratings for commercial real estate assets and the portfolio record. Accordingly, the real estate evaluation computing device the previous available real estate rating and compares it to a presently determined real estate rating (“present real estate rating”). For such a comparison to be effective, both the previous real estate rating and present real estate rating must be of the same type, and for the same real estate asset or portfolio record.

Further, each portfolio record and each commercial real estate asset may be associated with a rating threshold indicating a minimum amount of change in real estate rating necessary to trigger a user alert. The rating threshold allows a user to be informed of changes in real estate ratings when the rating threshold is exceeded. Upon determining that the difference between the present real estate rating and the previous real estate rating exceeds the rating threshold, the real estate evaluation computing device may transmit an alert to a user identifying the present real estate rating, the change in real estate rating, and the associated commercial real estate asset or portfolio record.

Present real estate ratings (whether for real estate assets or the portfolio record) may be stored at real estate evaluation computing device in a memory or any other suitable storage device. In some examples, historical real estate ratings may also be stored at real estate evaluation computing device.

### Monitoring Phase

As described herein, the real estate evaluation computing device is configured to actively monitor the portfolio record and each commercial real estate asset. In a first example, the real estate evaluation computing device re-executes the Evaluation Phase on demand to identify changes in the real estate ratings. Such re-execution may occur when the real estate evaluation computing device receives updates to any income factors, property factors, forecast factors, or merchant data.

The real estate evaluation computing device also monitors the portfolio record and each commercial real estate asset by identifying risks or potential changes to evaluations even when the real estate rating is not yet changed. In such examples, the real estate evaluation computing device receives merchant data and identifies early warning indicators that may be of importance to a user from the merchant data. Such early warning indicators may be similar to those described in the Evaluation Phase and may include, for example, changes in sales receipts, changes in average sales receipts, changes in social media mentions, changes in social media activity, changes in review data, changes in visit rates, and changes in other transaction trends and characteristics. Early warning indicators for monitoring may also include changes in comparative evaluations caused by changes in the average cost or value of similar commercial real estate assets that may be in the same neighborhood or geography as the instant real estate asset. Early warning indicators may also include changes to occupancy, impending terminations of commercial leases, delays of rental payments, and any other suitable information related to tenancy and occupancy of the commercial real estate asset.

In some embodiments, the real estate evaluation computing device stores merchant information and user information without including sensitive personal information, also known as personally identifiable information or PII, in order to ensure the privacy of individuals associated with the stored data. Personally identifiable information may include any information capable of identifying an individual. For privacy and security reasons, personally identifiable information may be withheld from the portfolio record. In some examples where privacy and security, such as through encryption, can otherwise be ensured, or where individuals consent, personally identifiable information may be retained in the portfolio record. In such examples, personally identifiable information may be needed to reports about groups of merchants or users. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

### Optimization Phase

The system is also configured to facilitate management of commercial real estate portfolios by simulating the impact of decisions that may be made in the management of the portfolio in an “Optimization Phase”. In one example, the system is configured to simulate the impact of a rental increase on the evaluation of a real estate asset. In such rental increase simulations, the real estate evaluation computing device may use previously determined rent tolerances and rental stability ratings to determine whether a merchant (or a group of merchants) may accept such a rental increase.

In a second example, “what-if” simulations may be carried out to simulate the impact of changing scenarios in the commercial real estate portfolio including the acquisition of neighboring properties and increasing property tax rates. In at least some embodiments, the system is configured to validate the evaluation information by comparing a previous evaluation to an external evaluation.

In some simulations, the real estate evaluation computing device may identify changes in commercial real estate ratings based on simulated changes to the capitalization rate, the asset price, transaction volumes, value per square foot, rating trends, and historic property values. A capitalization rate is represented as a ratio of the net operating income for the asset and the asset value.

Through the monitoring of commercial real estate portfolios, the systems and methods are further configured to facilitate (a) identify potential changes in the evaluation of real estate properties based on transaction data, (b) integrate merchant tenant financial data into the evaluation of real estate assets by linking transaction data received from interchange networks (or payment networks) to such a financial evaluation, and (c) improve the optimization of commercial real estate assets through improved rental pricing.

The technical effects of the systems and methods described herein can be achieved by performing at least one of the following steps: (a) receiving a set of property factors associated with a real estate asset, wherein the real estate asset is associated with a merchant renting the real estate asset; (b) receiving a set of income factors associated with the real estate asset; (c) receiving a previous real estate rating for the real estate asset; (d) receiving a set of merchant data associated with the merchant, the set of merchant data including a set of transaction data, wherein the set of transaction data is received at a payment network (or an interchange network); (e) determining a merchant revenue forecast based at least in part on the set of merchant data; (f) determining a present real estate rating for the real estate asset based on the set of property factors, the set of income factors, and the merchant revenue forecast; (g) determining that a difference between the present real estate rating and the previous real estate rating exceeds a rating threshold indicating a possible change in value of the real estate asset; (h) transmitting an alert to a user device indicating the possible change in value of the real estate asset; (i) determining a set of forecast factors associated with the real estate asset based on the set of income factors and the set of merchant data; (j) determining the merchant revenue forecast based on the set of forecast factors; (k) adjusting the present real estate rating based on the merchant revenue forecast; (l) determine a merchant revenue stability rating using the set of forecast factors, wherein the merchant revenue stability rating represents a capacity of the merchant to pay a rental fee associated with the real estate asset based on analysis of the set of merchant data; (m) identifying, based on the merchant revenue stability rating, a rent tolerance for the merchant; (n) alerting the user if the rent tolerance is different than a present rental rate associated with the merchant; (o) receiving social media data associated with the merchant; (p) adjusting the merchant revenue forecast based on the social media data; and (q) replacing the previous real estate rating with the present real estate rating.

The following detailed description of the embodiments of the disclosure refers to the accompanying drawings. The same reference numbers in different drawings may identify the same or similar elements. Also, the following detailed description does not limit the claims.

Described herein are computer systems such as real estate evaluation computing devices and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the monitoring, evaluation, and optimization of managed commercial real estate assets.

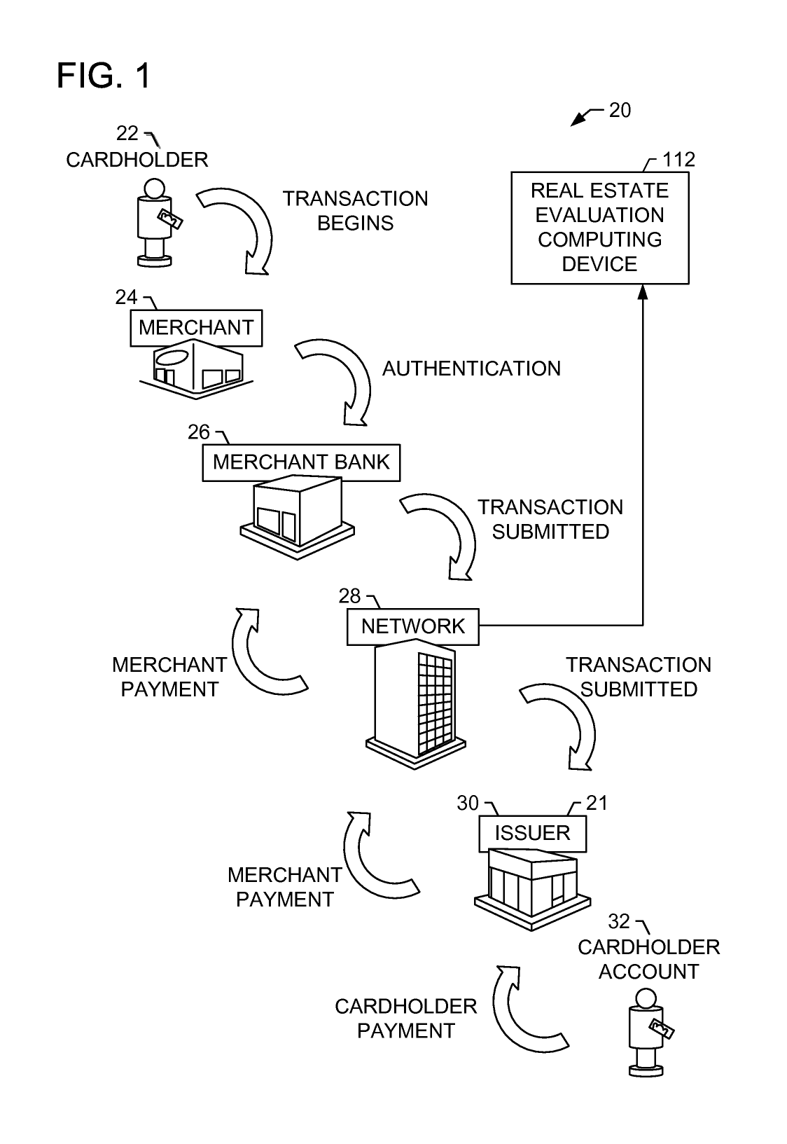

FIG. 1 is a schematic diagram illustrating an example multi-party payment card system 20 for enabling payment-by-card transactions and monitoring real estate assets in accordance with one embodiment of the present disclosure. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

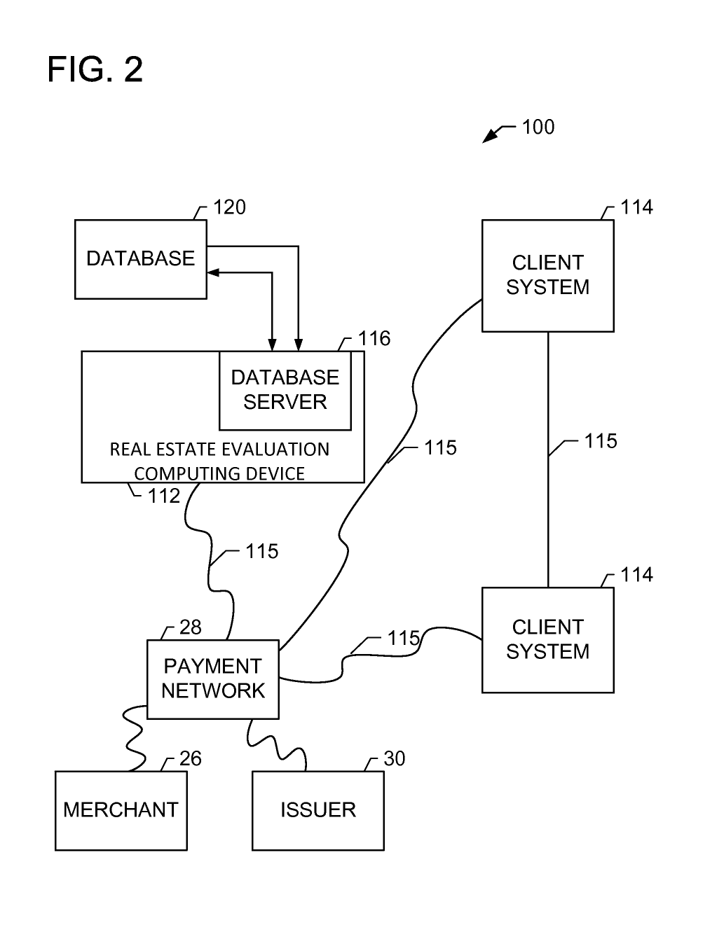

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including real estate evaluation computing device 112. In the example embodiment, interchange network 28 provides such transaction data (including merchant data associated with merchant tenants of each commercial real estate asset of each portfolio record) and additional transaction data. In alternative embodiments, any party may provide such data to real estate evaluation computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, real estate evaluation computing device 112 may be used to monitor, value, and optimize commercial real estate assets. Although the systems described herein are not intended to be limited to facilitate such applications, the systems are described as such for exemplary purposes.

FIG. 2 is an expanded block diagram of an example embodiment of a computer system 100 used in processing payment transactions that includes real estate evaluation computing device 112 in accordance with one example embodiment of the present disclosure. In the example embodiment, system 100 is used for monitoring, valuing, and optimizing commercial real estate assets, as described herein. In other embodiments, the applications may reside on other computing devices (not shown) communicatively coupled to system 100, and may monitor, value, and optimize commercial real estate assets using system 100.

More specifically, in the example embodiment, system 100 includes a real estate evaluation computing device 112, and a plurality of client sub-systems, also referred to as client systems 114, connected to real estate evaluation computing device 112. In one embodiment, client systems 114 are computers including a web browser, such that real estate evaluation computing device 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store data. Real estate evaluation computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on real estate evaluation computing device 112 and can be accessed by potential users at one of client systems 114 by logging onto real estate evaluation computing device 112 through one of client systems 114. In an alternative embodiment, database 120 is stored remotely from real estate evaluation computing device 112 and may be non-centralized. Database 120 may be a real estate database configured to store information used by real estate evaluation computing device 112 including, for example, property factors, income factors, merchant data, real estate ratings, real estate definition data, merchant stability ratings, rent tolerances, merchant revenue forecasts, and historical data.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data. Further, database 120 may function to store lookup tables and reference tables. Lookup tables may contain cardholder profiles that may identify a cardholder residence based on a cardholder identifier. Lookup tables may also identify whether a cardholder is a mobile cardholder. Reference tables contain typical ranges of travel. In some examples, reference tables include distinct typical ranges of travel for particular geographic regions, particular merchant categories, and other transaction or cardholder characteristics.

In the example embodiment, one of client systems 114 may be associated with acquirer bank 26 (shown in FIG. 1) while another one of client systems 114 may be associated with issuer bank 30 (shown in FIG. 1). Real estate evaluation computing device 112 may be associated with interchange network 28. In the example embodiment, real estate evaluation computing device 112 is associated with a network interchange, such as interchange network 28, and may be referred to as an interchange computer system. Real estate evaluation computing device 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

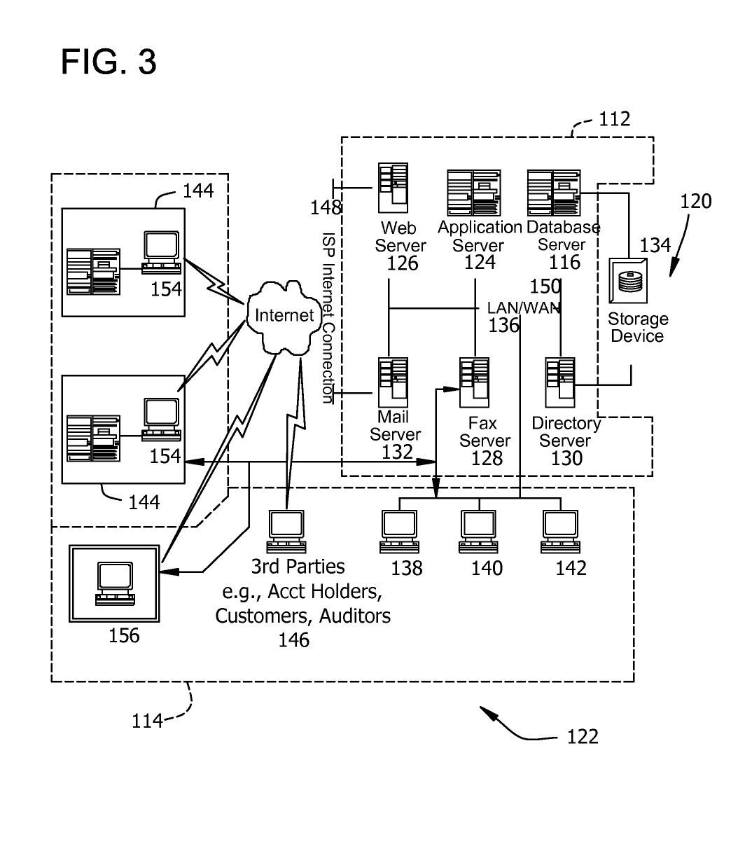

FIG. 3 is an expanded block diagram of an example embodiment of a computer device architecture of a system 122 used to monitor, value, and optimize commercial real estate assets in accordance with one example embodiment of the present disclosure. Components in system 122, identical to components of system 100 (shown in FIG. 2), are identified in FIG. 3 using the same reference numerals as used in FIG. 2. System 122 includes real estate evaluation computing device 112, client systems 114, and payment systems 118. Real estate evaluation computing device 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Real estate evaluation computing device 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Real estate evaluation computing device 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with real estate evaluation computing device 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with real estate evaluation computing device 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

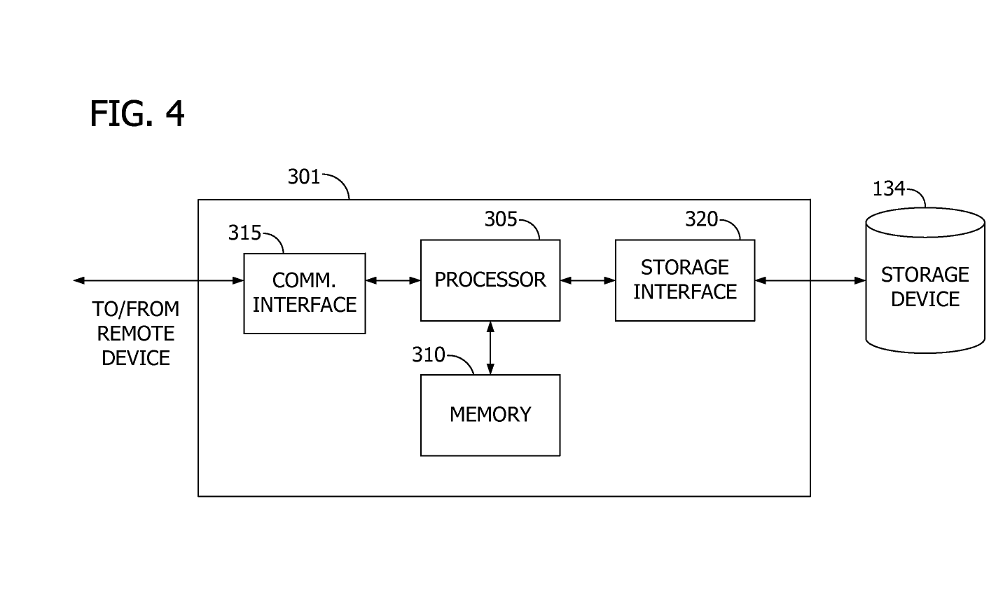

FIG. 4 illustrates an example configuration of a server system 301 such as real estate evaluation computing device 112 (shown in FIGS. 2 and 3) used to monitor, value, and optimize commercial real estate assets in accordance with one example embodiment of the present disclosure. Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

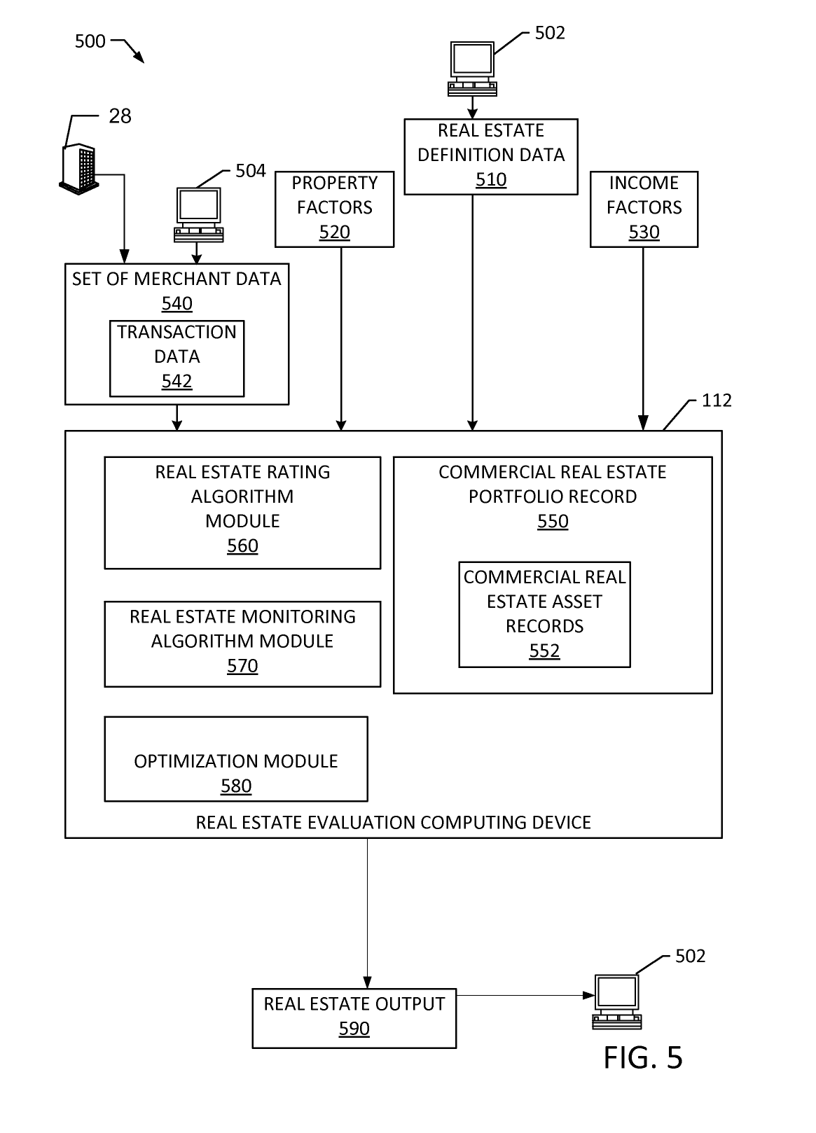

FIG. 5 is a simplified data flow diagram for monitoring real estate assets using real estate evaluation computing device 112. As described herein, real estate evaluation computing device 112 receives real estate definition data 510 from a user device 502 (such as a commercial lender or a commercial owner). Real estate evaluation computing device 112 defines a plurality of commercial real estate asset records 552 based on real estate definition data 510 in the Setup Phase as identified above and herein. Real estate evaluation computing device 112 further defines commercial real estate portfolio record 550 based on such real estate definition data 510.

Real estate evaluation computing device 112 also receives a plurality of property factors 520, a plurality of income factors 530, and a set of merchant data 540. Plurality of property factors 520 and plurality of income factors 530 may be received or retrieved from any suitable data source including real estate database 120 (shown in FIG. 2). Set of merchant data 540 may be retrieved at least partially from interchange network 28. Specifically, set of merchant data 540 includes information related to merchant transactions referred to as transaction data 542. Transaction data 542 may be received from interchange network 28. Other information including visit data, social media data, and online review data may be received from external systems such as external server 504.

Real estate evaluation computing device 112 includes a plurality of modules 560, 570, and 580 that facilitate the evaluation, monitoring, and optimization of commercial real estate assets. Specifically, real estate evaluation computing device 112 includes real estate rating algorithm module 560 configured to value each commercial real estate asset record 552 in commercial real estate portfolio record 550 (and record 550 itself) as specified in Evaluation Phase. Real estate evaluation computing device 112 also includes real estate monitoring algorithm module 570 configured to identify early warning indications associated with each commercial real estate asset record 552 in commercial real estate portfolio record 550 (and record 550 itself) as specified in Monitoring Phase. Real estate evaluation computing device 112 also includes optimization module 580 configured to perform optimization tasks for each commercial real estate asset record 552 in commercial real estate portfolio record 550 (and record 550 itself) as specified in Optimization Phase.

Real estate evaluation computing device 112 is also configured to provide a plurality of real estate outputs 590 as described herein. Specifically, real estate outputs 590 may include at least alerts regarding changes in real estate ratings, early warning indications, and optimization simulations.

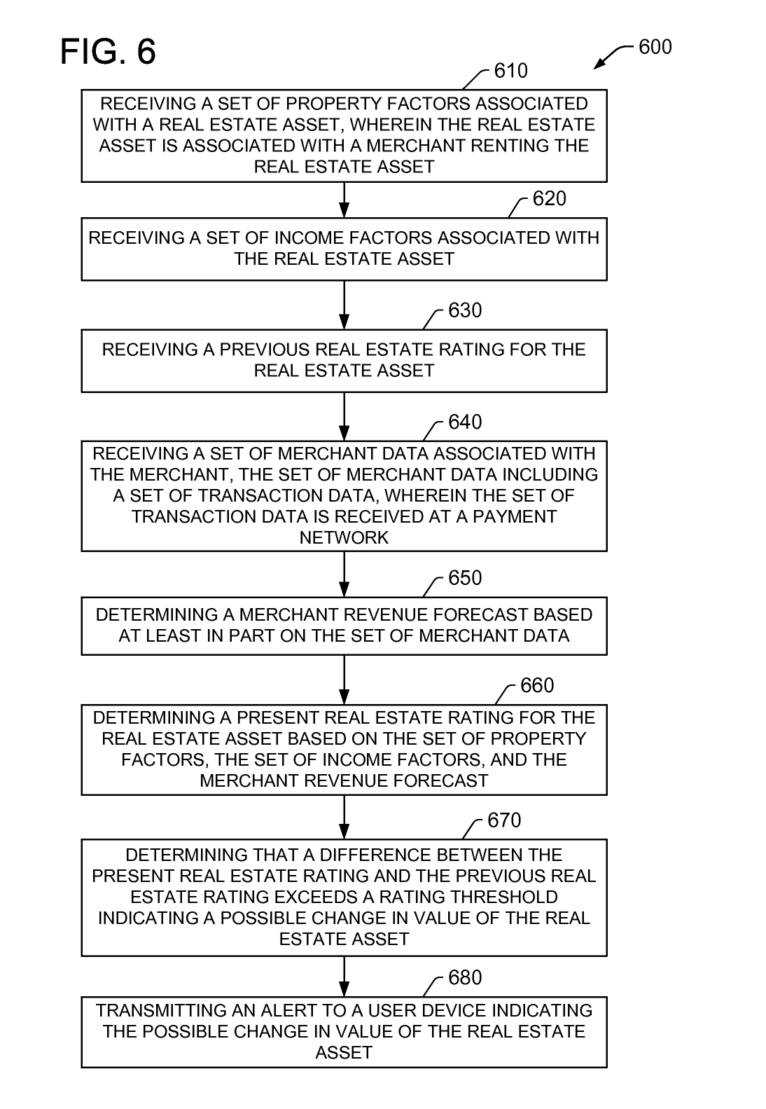

FIG. 6 is a simplified diagram of an example method for monitoring real estate assets using real estate evaluation computing device 112 (shown in FIG. 2). Specifically, real estate evaluation computing device 112 is configured to receive 610 a set of property factors associated with a real estate asset, wherein the real estate asset is associated with a merchant renting the real estate asset. Receiving 610 represents real estate evaluation computing device 112 receiving property factors 520 (shown in FIG. 5).

Real estate evaluation computing device 112 is also configured to receive 620 a set of income factors associated with the real estate asset. Receiving 620 represents real estate evaluation computing device 112 receiving income factors 530 (shown in FIG. 5).

Real estate evaluation computing device 112 is additionally configured to receive 630 a previous real estate rating for the real estate asset. Receiving 630 represents real estate evaluation computing device 112 retrieving or receiving a previous real estate rating for a real estate asset.

Real estate evaluation computing device 112 is also configured to receive 640 a set of merchant data associated with the merchant including a set of transaction data received at an interchange network. Receiving 650 represents real estate evaluation computing device 112 retrieving or receiving a set of merchant data 540 including transaction data 542 (both shown in FIG. 5).

Real estate evaluation computing device 112 is further configured to determine 650 a merchant revenue forecast based at least in part on the set of merchant data. Determining 650 represents real estate evaluation computing device 112 determining forecasted revenue associated with a merchant based on set of merchant data 540 and transaction data 542.

Real estate evaluation computing device 112 is also configured to determine 660 a present real estate rating for the real estate asset based on the set of property factors, the set of income factors, and the merchant revenue forecast. Determining 660 represents real estate evaluation computing device 112 applying real estate rating module algorithm 560 (shown in FIG. 5) to property factors 520, income factors 530, and the merchant revenue forecast to determine a real estate rating for a commercial real estate asset.

Real estate evaluation computing device 112 is also configured to determine 670 that a difference between the present real estate rating and the previous real estate rating exceeds a rating threshold indicating a possible change in value of the real estate asset and to transmit 680 an alert to a user device indicating the possible change in value of the real estate asset.

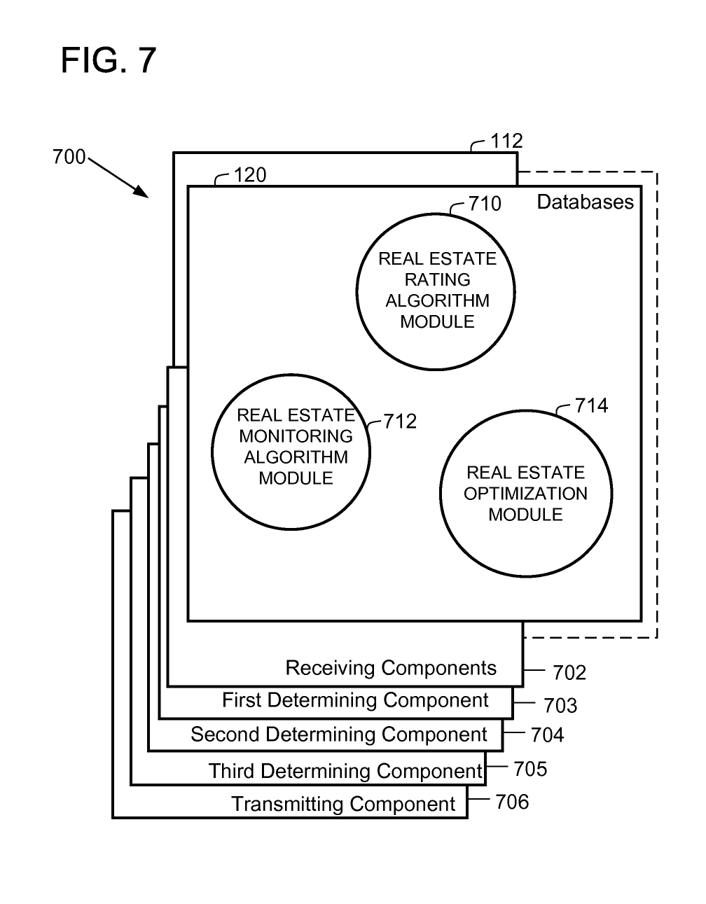

FIG. 7 is a diagram of components of one or more example computing devices that may be used in the environment shown in FIG. 2. FIG. 7 further shows a configuration of databases including at least database 120 (shown in FIG. 1). Database 120 is coupled to several separate components within real estate evaluation computing device 112, which perform specific tasks.

Real estate evaluation computing device 112 includes a receiving component 702 for receiving a set of property factors associated with a real estate asset, wherein the real estate asset is associated with a merchant renting the real estate asset, receiving a set of income factors associated with the real estate asset, receiving a previous real estate rating for the real estate asset, and receiving a set of merchant data associated with the merchant, the set of merchant data including a set of transaction data, wherein the set of transaction data is received at an interchange network. Real estate evaluation computing device 112 also includes a first determining component 703 for determining a merchant revenue forecast based at least in part on the set of merchant data. Real estate evaluation computing device 112 additionally includes a second determining component 704 for determining a present real estate rating for the real estate asset based on the set of property factors, the set of income factors, and the merchant revenue forecast. Real estate evaluation computing device 112 also includes a third determining component 705 for determining that a difference between the present real estate rating and the previous real estate rating exceeds a rating threshold indicating a possible change in value of the real estate asset. Real estate evaluation computing device 112 additionally includes a transmitting component 706 for transmitting an alert to a user device indicating the possible change in value of the real estate asset.

In an exemplary embodiment, database 120 is divided into a plurality of sections, including but not limited to, a real estate rating algorithm module 710, a real estate monitoring algorithm module 712, and a real estate optimization module 714. These sections within database 120 are interconnected to update and retrieve the information as required.

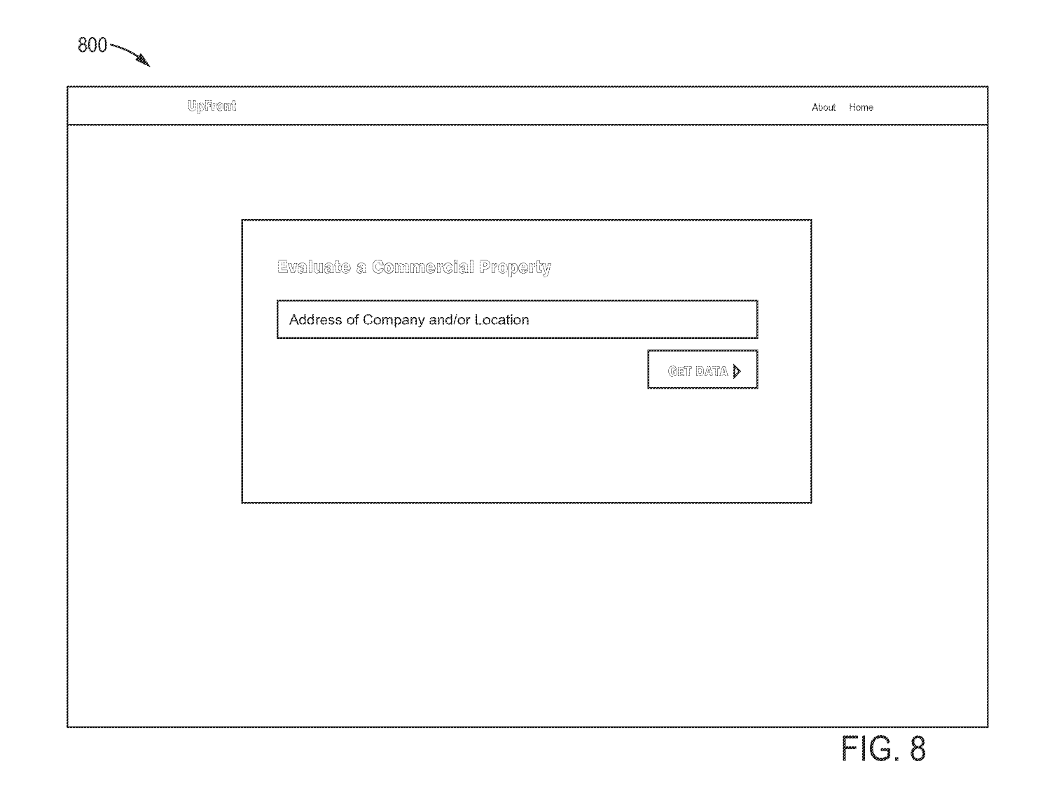

FIGS. 8-12 are illustrative screenshots provided by the real estate evaluation computing device 112 (FIG. 2) to allow the monitoring of real estate assets in accordance with one example embodiment of the present disclosure.

FIG. 8 illustrates a first screen shot 800 provided to a user device by real estate evaluation computing device 112 in the Setup Phase. Specifically, in screen shot 800, a user may provide a location for a commercial real estate asset and thereby provide real estate definition data 510 (shown in FIG. 5).

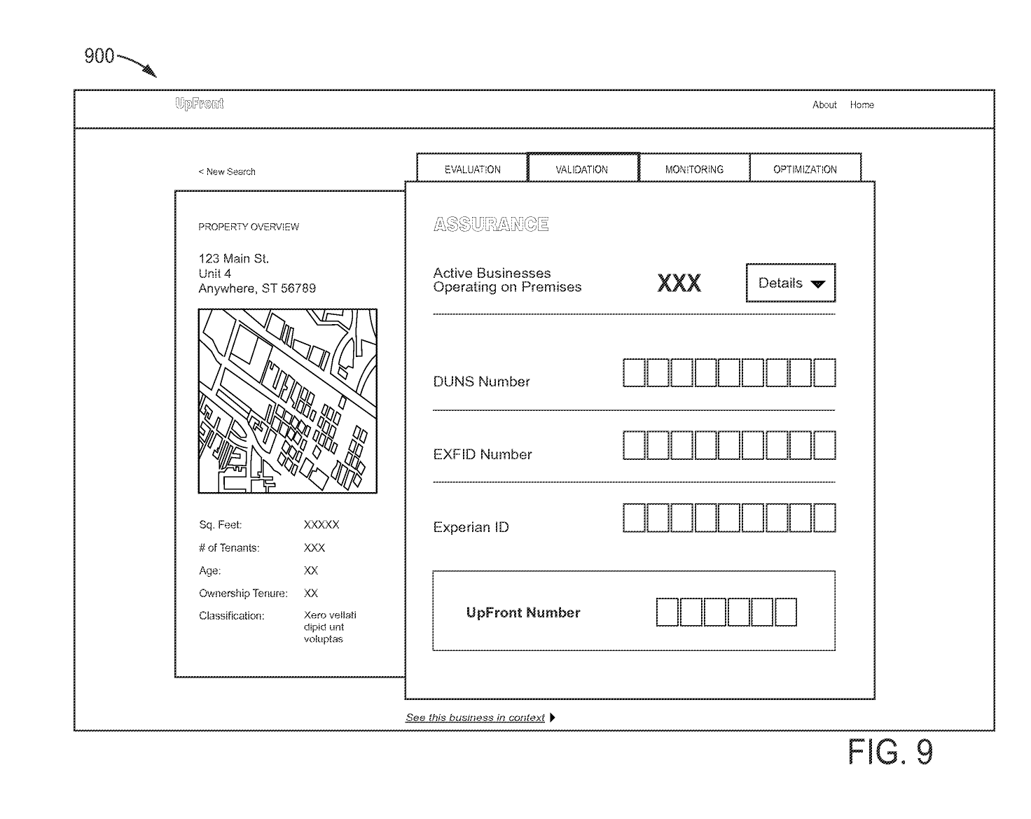

FIG. 9 illustrates a second screen shot 900 provided to a user device by real estate evaluation computing device 112 in the Validation Phase. Specifically, in screen shot 900, a user may verify that information presented for a commercial real estate portfolio record 550 (shown in FIG. 5) accurately represents the associated commercial real estate portfolio. Further, information related to merchant tenants may be validated in screen shot 900.

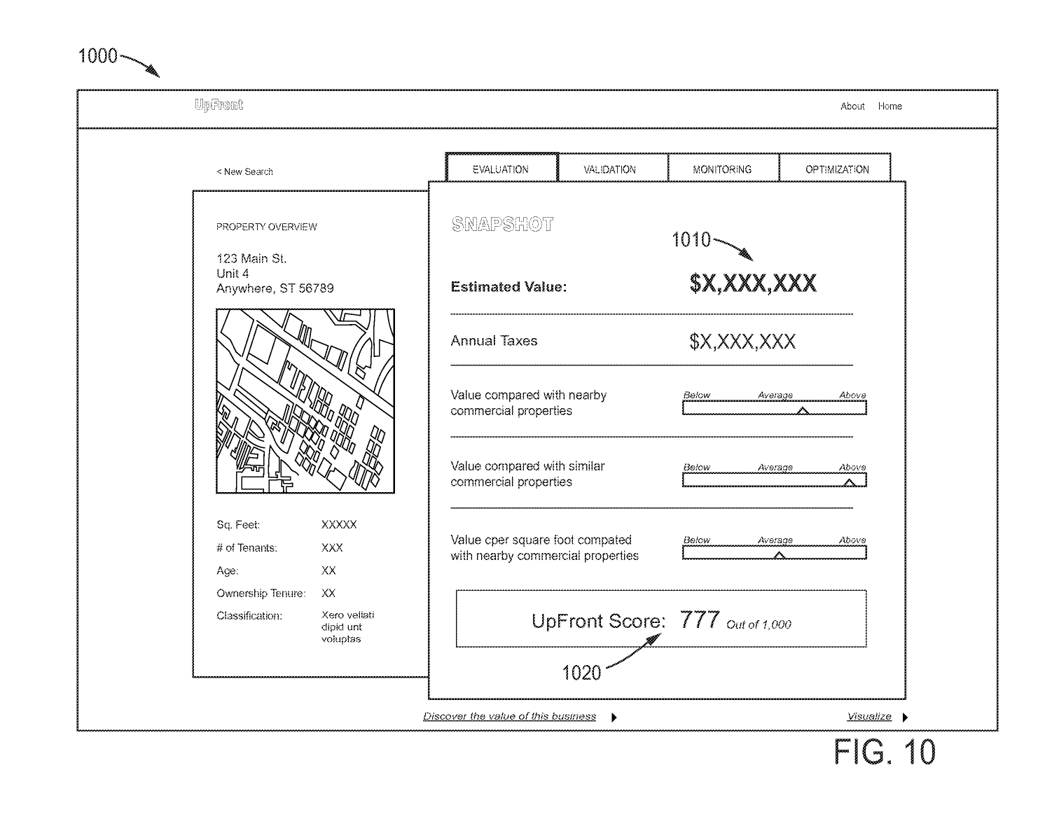

FIG. 10 illustrates a third screen shot 1000 provided to a user device by real estate evaluation computing device 112 in the Evaluation Phase. Specifically, in screen shot 1000, a user may obtain real estate ratings and evaluations as described in the Evaluation Phase above for commercial real estate asset records 552 (shown in FIG. 5). In screen shot 1000, at least two real estate ratings 1010 and 1020 are provided. Real estate rating 1010 reflects a financial evaluation of a commercial real estate asset while real estate rating 1020 reflects a relative score of the commercial real estate asset. Screen shot 1000 also includes additional information that may be provided in the Evaluation Phase including tax rates and tax levels, comparisons of the asset's value to the value of similar properties, comparisons of the asset's value to the value of nearby properties, and comparisons of the asset's per-square-foot value to that of nearby commercial properties.

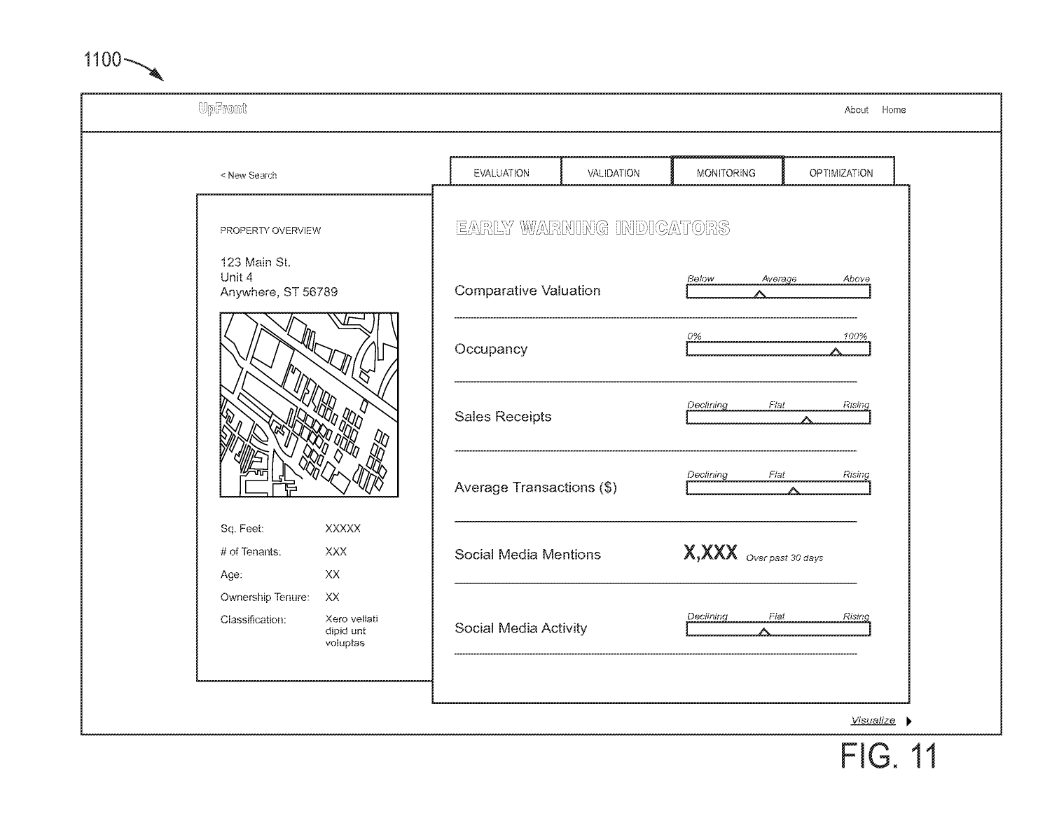

FIG. 11 illustrates a fourth screen shot 1100 provided to a user device by real estate evaluation computing device 112 in the Monitoring Phase. Specifically, in screen shot 1100, a user may review a variety of “early warning indicators” as described above and herein. Such early warning indicators may indicate potential changes in real estate ratings. As shown in screen shot 1100, early warning indicators may include comparative evaluations to nearby commercial properties, occupancy levels for the commercial real estate asset, sales receipts for the merchant tenant of the commercial real estate asset, average transaction amounts for the merchant tenant of the commercial real estate asset, social media mentions for the merchant tenant of the commercial real estate asset, and social media activity for the merchant tenant of the commercial real estate asset.

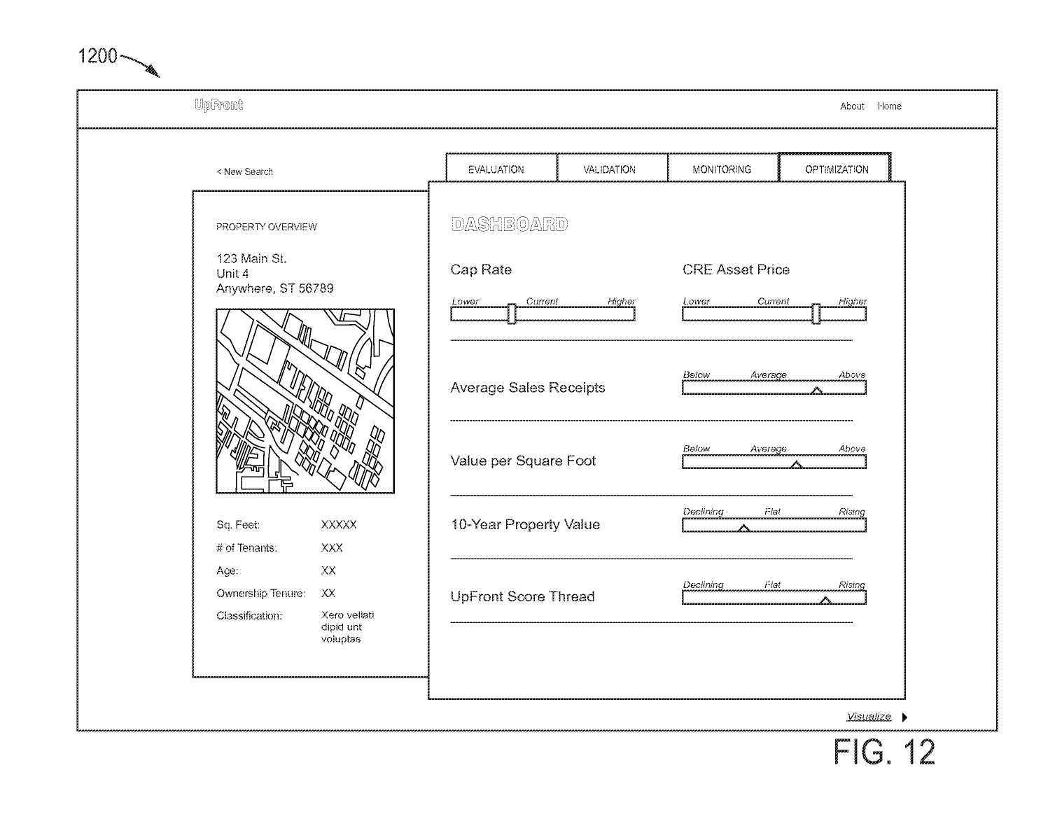

FIG. 12 illustrates a fifth screen shot 1200 provided to a user device by real estate evaluation computing device 112 in the Optimization Phase. Specifically, in screen shot 1200, a user may simulate a variety of scenarios that may affect the real estate rating of the commercial real estate asset.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for evaluating real estate assets, the method implemented by a real estate evaluation computing device in communication with a memory, the method comprising:
receiving a set of property factors associated with a real estate asset, wherein the real estate asset is associated with a merchant renting the real estate asset;
receiving a set of income factors associated with the real estate asset;
receiving a previous real estate rating for the real estate asset;
receiving a set of merchant data associated with the merchant, the set of merchant data including a set of transaction data, wherein the set of transaction data is received at an interchange network;
determining a merchant revenue forecast based at least in part on the set of merchant data;
determining a present real estate rating for the real estate asset based on the set of property factors, the set of income factors, and the merchant revenue forecast;
determining that a difference between the present real estate rating and the previous real estate rating exceeds a rating threshold indicating a possible change in value of the real estate asset; and
transmitting an alert to a user device indicating the possible change in value of the real estate asset.

2. The method of claim 1, further comprising:
determining a set of forecast factors associated with the real estate asset based on the set of merchant data;
determining the merchant revenue forecast based on the set of forecast factors; and
adjusting the present real estate rating based on the merchant revenue forecast.

3. The method of claim 2, further comprising:
determining a merchant revenue stability rating using the set of forecast factors, wherein the merchant revenue stability rating represents a capacity of the merchant to pay a rental fee associated with the real estate asset based on analysis of the set of merchant data.

4. The method of claim 3, further comprising:
identifying, based on the merchant revenue stability rating, a rent tolerance for the merchant; and
alerting the user if the rent tolerance is different than a present rental rate associated with the merchant.

5. The method of claim 1, further comprising:
receiving social media data associated with the merchant; and
adjusting the merchant revenue forecast based on the social media data.

6. The method of claim 1, further comprising:
replacing the previous real estate rating with the present real estate rating.

7. The method of claim 1, further comprising:
receiving the previous real estate rating from an external rating service.

8. A real estate evaluation computing device for evaluating real estate assets, the real estate evaluation computing device comprising a memory for storing data, and a processor in communication with the memory, said processor programmed to:
receive a set of property factors associated with a real estate asset, wherein the real estate asset is associated with a merchant renting the real estate asset;
receive a set of income factors associated with the real estate asset;
receive a previous real estate rating for the real estate asset;
receive a set of merchant data associated with the merchant, the set of merchant data including a set of transaction data, wherein the set of transaction data is received at an interchange network;
determine a merchant revenue forecast based at least in part on the set of merchant data;
determine a present real estate rating for the real estate asset based on the set of property factors, the set of income factors, and the merchant revenue forecast;
determine that a difference between the present real estate rating and the previous real estate rating exceeds a rating threshold indicating a possible change in value of the real estate asset; and
transmit an alert to a user device indicating the possible change in value of the real estate asset.

9. The real estate evaluation computing device of claim 8, wherein the processor is further programmed to:
determine a set of forecast factors associated with the real estate asset based on the set of merchant data;
determine the merchant revenue forecast based on the set of forecast factors; and
adjust the present real estate rating based on the merchant revenue forecast.

10. The real estate evaluation computing device of claim 9, wherein the processor is further programmed to:
determine a merchant revenue stability rating using the set of forecast factors, wherein the merchant revenue stability rating represents a capacity of the merchant to pay a rental fee associated with the real estate asset based on analysis of the set of merchant data.

11. The real estate evaluation computing device of claim 10, wherein the processor is further programmed to:
identify, based on the merchant revenue stability rating, a rent tolerance for the merchant; and
alert the user if the rent tolerance is different than a present rental rate associated with the merchant.

12. The real estate evaluation computing device of claim 8, wherein the processor is further programmed to:
receive social media data associated with the merchant; and
adjust the merchant revenue forecast based on the social media data.

13. The real estate evaluation computing device of claim 8, wherein the processor is further programmed to:
replace the previous real estate rating with the present real estate rating.

14. The real estate evaluation computing device of claim 8, wherein the processor is further programmed to:
receive the previous real estate rating from an external rating service.

15. A computer-readable storage device, having processor-executable instructions embodied thereon, for evaluating real estate assets, wherein the computer includes at least one processor and a memory coupled to the processor, wherein, when executed by the computer, the processor-executable instructions cause the computer to:
receive a set of property factors associated with a real estate asset, wherein the real estate asset is associated with a merchant renting the real estate asset;
receive a set of income factors associated with the real estate asset;
receive a previous real estate rating for the real estate asset;
receive a set of merchant data associated with the merchant, the set of merchant data including a set of transaction data, wherein the set of transaction data is received at an interchange network;
determine a merchant revenue forecast based at least in part on the set of merchant data;
determine a present real estate rating for the real estate asset based on the set of property factors, the set of income factors, and the merchant revenue forecast;
determine that a difference between the present real estate rating and the previous real estate rating exceeds a rating threshold indicating a possible change in value of the real estate asset; and
transmit an alert to a user device indicating the possible change in value of the real estate asset.

16. The computer-readable storage device of claim 15, wherein the processor-executable instructions cause the computing device to:
determine a set of forecast factors associated with the real estate asset based on the set of merchant data;
determine the merchant revenue forecast based on the set of forecast factors; and
adjust the present real estate rating based on the merchant revenue forecast.

17. The computer-readable storage device of claim 16, wherein the processor-executable instructions cause the computing device to:
determine a merchant revenue stability rating using the set of forecast factors, wherein the merchant revenue stability rating represents a capacity of the merchant to pay a rental fee associated with the real estate asset based on analysis of the set of merchant data.

18. The computer-readable storage device of claim 17, wherein the processor-executable instructions cause the computing device to:
identify, based on the merchant revenue stability rating, a rent tolerance for the merchant; and
alert the user if the rent tolerance is different than a present rental rate associated with the merchant.

19. The computer-readable storage device of claim 15, wherein the processor-executable instructions cause the computing device to:
receive social media data associated with the merchant; and
adjust the merchant revenue forecast based on the social media data.

20. The computer-readable storage device of claim 15, wherein the processor-executable instructions cause the computing device to:
replace the previous real estate rating with the present real estate rating.
